(19) United States
(12) Patent Application Publication
(10) Pub. No.: US 2010/0100468 A1
(43) Pub. Date: Apr. 22, 2010

(54) SYSTEM AND METHOD FOR MULTI LAYER RULE PROCESSING BACKGROUND

(76) Inventors: Omri SPECTOR, Tel-Aviv (IL); Paul Gerald Henninger, Brooklyn, NY (US); David Govrin, Hertzelia (IL); Michael Oland, Tel Aviv (IL); Boaz Peer, Gan Haim (IL)

Correspondence Address: Pearl Cohen Zedek Latzer, LLP, 1500 Broadway, 12th Floor, New York, NY, 10036, US

(21) Appl. No.: 12/254,455

(22) Filed: Oct. 20, 2008

(51) Int. Cl. G06Q 10/00

(52) U.S. Cl. 705/35

(57) ABSTRACT

A system and method for processing a digital transaction using a layered rule architecture. Any number of rules may be applied to or tested against a transaction record. Rules and associated actions may be associated with priorities. A conflict resolution method or logic may be used to select one or more actions from a set of actions resulting from applying a set of rules to a transaction record.

### BACKGROUND

Advancements in computing and communication technologies have enabled significant changes in the way financial institutions, businesses, organizations, government agencies and-the like operate and function. In many such organizations, institutions or agencies, electronic business documents or transactions comprise the formal and/or official form of transacting business. A large number and variety of documents and transactions are regularly exchanged between, for example, agencies and business partners, financial institutions and the private sector regardless of distance and geographic location.

Financial and other institutions may need to process large amounts of monetary or other transactions on a daily basis. Many of these transactions involve a transfer of confidential, sensitive and/or private information or data as well as comprise business transactions such as purchase orders or money transfers. For example, many such transactions involve a transfer of money, e.g., between bank accounts. Some of these transactions may be a result of fraudulent activity. For example, a “fraudster” may use a transaction to transfer money from its rightful owner's bank account to an account maintained or owned by the fraudster. If not blocked before processing, such fraudulent transactions or transfers may cause a direct loss of money.

Identifying and/or detecting fraudulent transactions may be a complicated task, and given the high volumes, time constraints and complexity, typically involve automated and/or semi-automated fraud identification and/or detection systems coupled with some level of human surveillance. For example, analytical models implemented in software, written by programmers and/or mathematicians, incorporating complex logic may be used to identify, detect and/or prevent fraud. Other means of detection and/or prevention of fraudulent transactions may be statistical analysis of historical data, possibly coupled with predictive modeling capabilities or ad-hoc querying of historical data coupled with manual surveillance, for example, using a case management tool as known in the art. Such means and tools may allow a business analyst or other, possibly novice users to query historic data, attempting to identify historical fraud events.

Analytical models implemented in software may allow powerful analytics and real-time prevention but may lack the usage flexibility of the ad-hoc querying of historical data. In contrast, querying of historical data by various available tools may limit the user to relatively simple rules, as the creation of complex key fraud indicators and pattern identification structures may not be possible without the use of highly technical complex modeling techniques and tools.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 shows a high level block diagram of a fraud detection environment according to embodiments of the invention;

FIG. 2A shows a logical block diagram of a fraud detection system according to embodiments of the invention;

FIG. 2B depicts a system, according to one embodiment of the present invention;

FIG. 3 shows a logical block diagram of a data and rule processing unit according to embodiments of the invention.

FIG. 4 shows a logical block diagram of a rule execution engine according to embodiments of the invention; and

FIG. 5 depicts an exemplary flowchart for conflict resolution according to embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like.

Unless explicitly stated, the method embodiments described herein are not constrained to a particular order or sequence. Additionally, some of the described method embodiments or elements thereof can occur or be performed at the same point in time.

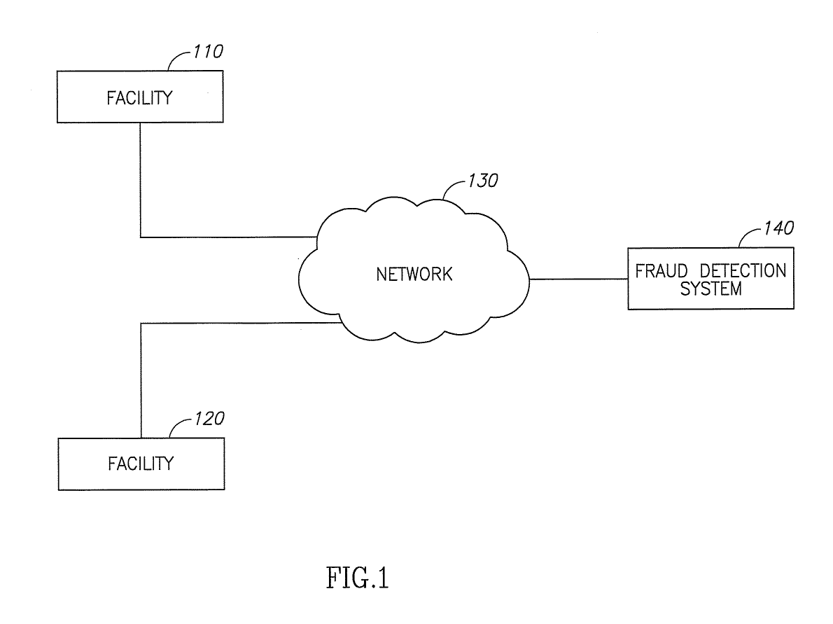

Reference is now made to FIG. 1, illustrating a high level block diagram of an exemplary fraud detection and/or anti-money laundering (AML) environment according to embodiments of the invention. As shown, such an environment may comprise facilities 110 and 120, network 130 and fraud detection and/or AML system 140. According to embodiments of the invention, by for example, processing money transactions, system 140 may detect fraudulent activities such as unauthorized money transfers or money laundering. Other activities or transactions may be detected by system 140, for example, as described herein, system 140 may be configured to detect transactions associated with, for example, terrorist financing. Each of facility 110 and facility 120 may be a financial facility such as a bank or any commercial or other facility. For example, each of facilities 110 and/or 120 may be an agency, e.g., a government agency or an international, e.g., United Nations (UN) facility. According to embodiments of the invention, facilities 110 and 120 may be any organization, institution or agency that may be at risk of fraudulent activities such as fraudulent electronic transactions, e.g., a money transfer or deposit transaction. While only two facilities are shown, any number of facilities may be used with embodiments of the present invention.

According to embodiments of the invention, network 130 may be, may comprise or may be part of a private Internet protocol (IP) network, the Internet, a wide area network (WAN), any combination of the preceding and/or any other suitable communication infrastructure or means. It will be recognized that embodiments of the invention are not limited by the nature of network 130. According to embodiments of the invention, fraud detection system 140 may comprise hardware, software, firmware and/or any applicable equipment, infrastructure and means required for, for example, performing fraud detection.

According to embodiments of the invention, transactions involving or otherwise associated with facility 110 may be forwarded for processing to fraud detection system 140 by facility 110. For example, a transaction received by facility 110 may be forwarded to system 140 for processing and fraud detection, possibly over a network other than network 130. System 140, after processing the transaction, may return results to facility 110. Alternatively, transactions being sent to facility 110 may be routed via system 140. For example, transactions originating at facility 120 and destined for facility 110 may be routed via system 140. Such transactions may be processed by system 140 either prior or at the same time they are received by facility 110. Alternatively, system 140 may operate in off-line mode and, for example, process past or historical transactions, possibly retrieved from a database or data warehouse. For example, historical transaction may be extracted from a repository maintained by facility 110 or facility 120, communicated to system 140 for processing and associated results pertaining to such historical transactions may be returned by system 140 to the originating facility or system or to another, possibly preconfigured entity.

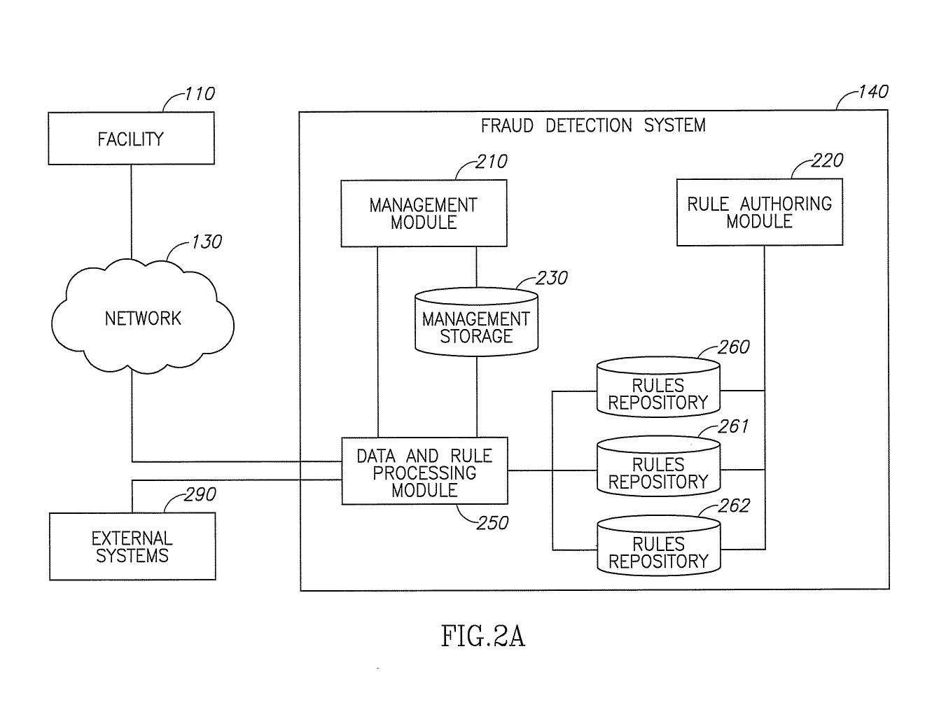

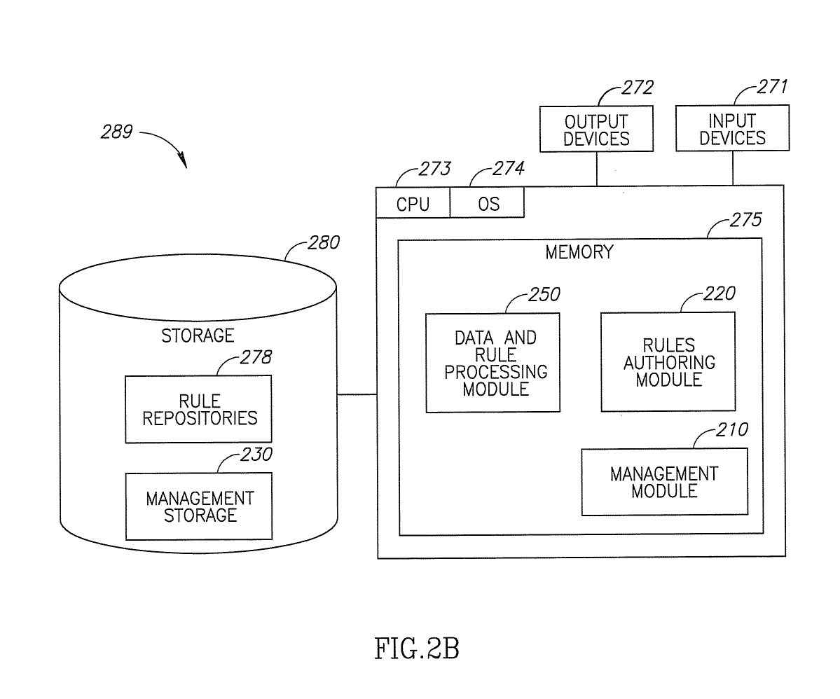

Reference is now made to FIG. 2A, showing a high level, logical block diagram of an exemplary fraud detection system according to embodiments of the invention. As shown in FIG. 2, facility 110 may be connected via network 130 to fraud detection system 140. According to embodiments of the invention, system 140 may perform functions in the fields of fraud detection and AML, e.g., money laundering detection and/or money transaction associated with fraudulent activities. Additional functions may be for example confirmation, corroboration, substantiation, authentication, certification, approval, granting permission, and/or affirmation. Such functions may be performed by system 140 with respect to input data as detailed herein. For example, electronic transactions may be confirmed, certified, authenticated or approved by system 140. Alternatively, output provided by system 140 may be used by additional systems or modules to perform such functions.

According to embodiments of the invention, fraud detection system 140 may include a management module 210, a rules and policies authoring module or unit 220, management storage 230, rule repositories 260, 261 and 262 and a data and rules processing module 250. According to embodiments of the invention, rule authoring module 220 may be or may comprise any suitable modules, tools, systems or platforms for defining, editing, authoring or otherwise manipulating rules, models and/or policies. For example, modeling language written in the Actimize IDE™, Analyst language written by Case Management tools and/or DLLs written by programmers may all be used for authoring rules that may be executed by fraud detection system 140.

According to embodiments of the invention, rules and policies may be composed or authored by any type of users. For example, analytical rules or models may typically be authored or manipulated by technical personnel, e.g., mathematicians, statistics oriented or skilled personnel or professionals or software engineers and the like while business oriented rules, events or policies may be defined by business oriented personnel who may not necessarily be technically oriented and who may define and author policies and rules pertaining to business objectives. Accordingly, module 220 may comprise a diverse variety of tools, platforms and modules enabling a respective variety of personnel, skilled and/or unskilled stuff or users to contribute a diverse selection of rules, policies, and/or event definitions to be used as input to data and rule processing module 250 as will be described herein.

According to embodiments of the invention, rules defined by any module or other component of rule authoring module 220 and further used by data and rule processing module 250 may be for example descriptive and/or quantitative. For example, a descriptive rule may refer to various descriptive aspects of a transaction, for example, customer's age, a type of account, or a type of transaction. Such rule may further define actions or decisions to be enforced when predefined conditions are met, for example, if the age of the customer associated with the transaction is below a predefined age then block the transaction or detect all transactions from/to private accounts (as oppose to accounts of commercial institutes). A quantitative rule may be associated with measurable, quantifiable parameters, e.g., such a rule may detect or flag transactions associated with sums greater than $100. According to embodiments of the invention, module 220 may comprise graphical user interface (GUI) tools for locating, retrieving, editing, changing or otherwise manipulating rules and policies. For example, such tools may provide a user with a graphical view of rules stored in one of rules repositories 260, 261 and/or 262. Such tool may further enable a user to load one or more rules or policy definitions, graphically or otherwise manipulate such loaded rules and store the modified rules in one of rules repositories 260, 261 and/or 262. One exemplary such authoring tool may be the Web Policy Rule Editor™ incorporated in Actimize's Risk Case Manager. It will be recognized that embodiments of the invention are not limited by the type, nature, operational and/or design aspects of rule authoring module 220. Accordingly, any applicable or suitable authoring tools may be employed by embodiments of the invention without departing from the scope of the present invention.

Rules repositories 260, 261 and 262 may be or may comprise any suitable storage module, platform, system, sub-system or infrastructure. Such infrastructure may comprise any general purpose, possibly off-the-shelf storage facilities or it may comprise dedicated, specific storage modules, sub-systems or devices. For example, repositories 260, 261 and 262 may comprise or be a hard drive or disk, any type of removable media, or a network storage device.

According to embodiments of the invention, rules and policies may be divided or distributed over a number of repositories, e.g., 260, 261 and 262 according to various considerations. For example, in some embodiments, repository 260 may store policies, repository 261 may store rules and repository 262 may store analytical rules. Other consideration, e.g., implementation constraints or cost, may affect such decisions. For example, rules authored by a first authoring tool selected from authoring module 220 may be stored in repository 260, rules authored by a second authoring tool may be stored in repository 261 and so on. It will be recognized that the scope of the present invention is not limited or otherwise affected by the number, type, nature, operational and/or design aspects of rules repositories 260, 261 and 262. For example, more or fewer repositories (e.g., one) may be employed by embodiments of the invention without departing from the scope of the present invention.

According to embodiments of the invention, data and rules processing module 250 may be provided with input from sources external to system 140. For example, transactions originating at facility 110 may be communicated over network 130 and received by processing module 250. Processing module 250 may be connected to rules repositories 260, 261 and 262 and may further utilize rules stored therein to process input data. Further details pertaining to operational and other aspects of processing module 250 will be discussed herein.

According to embodiments of the invention, data and rules processing module 250 may be connected to management storage 230 and to management and management module 210. According to embodiments of the invention, management storage 230 may store any relevant or applicable information. For example, alerts and warnings produced by data and rules processing module 250 may be stored in management storage 230. Such alerts may be produced as a result of applying rules to or comparing rules with transactions. For example, various events or conditions detected in a transaction may cause warnings and/or alerts to be produced. According to embodiments of the invention, other than being sent to external systems and/or displayed on a display by a management tool, alerts and warnings may be stored in storage 230 and may further be examined at a later stage. Other information, parameters and data, possibly produced or provided by processing module 250 as will be described herein may also be stored in management storage 230. For example, any relevant case management information, possibly produced by module 250 may be stored in management storage 230.

Information stored in management storage 230 may be retrieved by one or more modules, systems or sub-systems comprising management and management module 210. Such information may further be edited or otherwise manipulated and the altered data or information may be stored in management storage 230.

Storage 230 may be or may comprise any suitable storage module, platform, system, sub-system or infrastructure. Such storage infrastructure may comprise any general purpose, possibly off-the-shelf storage facilities or it may comprise dedicated, specific storage modules, sub-systems or devices. For example, management storage 230 may comprise or be a hard drive or disk, any type of removable media, or a network storage device.

According to embodiments of the invention, management module 210 may comprise user interface tools to enable user interaction with various components of system 140. Typically, such tools may be case management tools as known in the art. According to embodiments of the invention, management module 210 may comprise GUI tools to enable a user to view statistical information such as number of transactions inspected, number of possible fraud attempts detected or any other case management information, parameters or indications pertaining to data processed by system 140. According to embodiments of the invention, information presented to a user may be rate parameters, e.g., number of transactions per second or hour, number of risks identified per second, date and time information associated with inspected transactions and the like. According to embodiments of the invention, management module 210 may provide real-time information, e.g., information described herein may be presented in real-time, as it is being detected by, for example, processing module 250. Other information, such as warnings, alerts, thresholds violation and evaluations of rule sets may also be presented by one or more systems, sub-systems, modules or other components comprising management module 210. According to embodiments of the invention, management module 210 may be or may comprise any applicable user interface system or module, for example, management module 210 may comprise Actimize's case management system. It will be recognized that embodiments of the invention are not limited by the type, nature, operational and/or design aspects of management and management module 210. Accordingly, any applicable or suitable management and/or interface tools may be employed or be incorporated in management module 210 without departing from the scope of the present invention.

According to embodiments of the invention, external systems 290 may include any applicable systems that may, in response to receiving an action, execute the action. One exemplary an external system 290 may be a recording system, device or module. Another exemplary an external system 290 may be a reporting system, for example, one that handles suspicious activity report (SAR) or office of foreign assets control (OFAC) reports. Exemplary actions that may be sent by module 250 and received and executed by external systems 290 may be, for example, blocking a transaction, allowing a transaction to proceed, logging a transaction, e.g., recording details such as time of the transaction, source and destination of the transaction and the like, and/or manipulating, e.g., altering a transaction. Any applicable system, device or application, e.g., transaction routing systems, transaction handling systems or various management applications may be considered by embodiments of the invention as external system and may further be interfaced with by data and rules processing module 250. According to embodiments of the invention, module 250 may cause external systems 290 to act by sending them one or more actions to be performed. According to embodiments of the invention, an action stream may be produced by module 250 and may further be sent or otherwise communicated to relevant external systems as shown.

Reference is made to FIG. 2B showing a computing device 289 capable of performing fraud detection, AML functions and other functions discussed herein. According to embodiments of the invention, computing device 289 may include a memory 275, central processing unit (CPU) or controller 273, storage device 280, an operating system (OS) 274, input device(s) 271 and output device(s) 272. According to embodiments of the invention, storage device 280 may be any suitable storage device, e.g., a hard disk, input devices 271 may include a mouse, a keyboard or any suitable input devices and output devices 272 may include one or more displays, speakers and/or any other suitable output devices. Input devices 271 and/or output devices 272 may comprise any applicable input/output (I/O) devices such as a network interface card (NIC), universal serial bus (USB) interface module or any other I/O devices. According to embodiments of the invention and as shown by 278, rule repositories may be stored on storage device 280. For example, rule repositories 260, 261 and 262 described herein may be stored on storage device 280. According to embodiments of the invention and as shown, management storage 230 described herein may be stored on device 280.

According to embodiments of the invention, rules authoring module 220 may be loaded into memory 275 and may be executed by for example CPU 273. For example, any software tools or application included in module 220 may be loaded into memory 275 and executed by CPU 273. Such execution may comprise performing functions as described with reference to module 220 herein. According to embodiments of the invention, management module 210 may be loaded into memory 275 and may be executed by CPU 273. Such execution may comprise performing functions as described with reference to module 210 herein. For example, any software tools or application included in module 210 may be loaded into memory 275 from storage device 280 or any other storage and executed by CPU 273. According to embodiments of the invention, data and rule processing module 250 may be loaded into memory 275 and may be executed by CPU 273. Module 250 may include a number of functional modules that may be implemented as separate software modules, such software modules may be loaded separately or together into memory 275 and may be executed from memory 275 by CPU 273. Such execution may comprise performing functions as described with reference to module 250 herein.

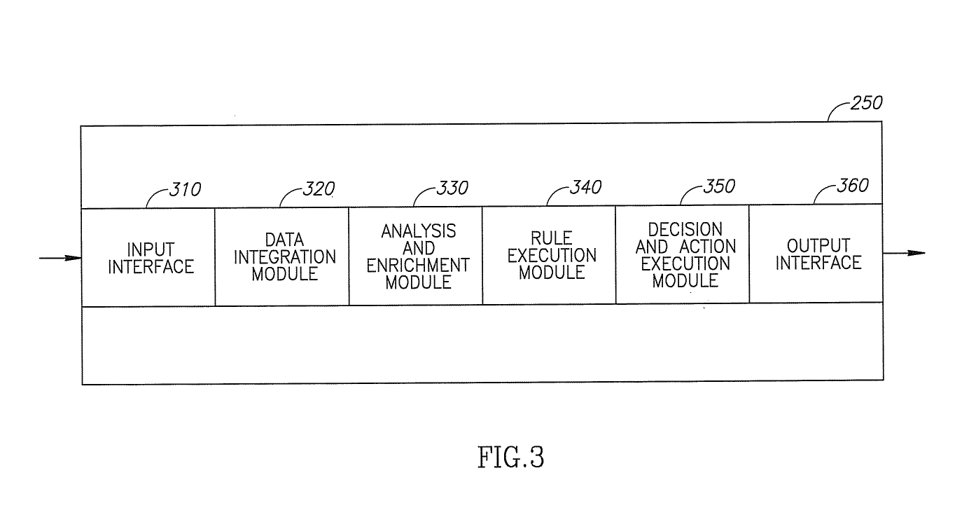

Reference is now made to FIG. 3 showing a logical block diagram of a data and rule processing module 250 according to embodiments of the invention. According to embodiments of the invention, module 250 may perform rule processing, rule evaluation, rules and/or action conflict resolution and may further interface with various components, either internal to system 140 or external to system 140 as described herein. According to embodiments of the invention, processing module 250 may comprise input interface 310, data integration module 320, analysis and enrichment module 330, rule execution module 340, decision and action execution module 350 and output interface 360. These modules are described herein.

Input interface 310 may comprise hardware, software, firmware or any combination of the preceding. According to embodiments of the invention, input interface 310 may perform any transformation, conversion or other software and/or hardware adaptation of input signals and/or data. For example, such input may be electronic transactions originating from facility 110 as shown by FIG. 2. Such adaptation may be required in order to suitably prepare input information for further processing by components comprising processing module 250. For example, input interface 310 may comprise hardware components such as a network interface card and/or firmware that may be installed and executed on such NIC. Input interface 310 may further comprise software components that may manipulate input data. For example, input interface 310 may buffer input data, determine a complete transaction has been received and provide such transaction for processing by other stages and/or modules of processing module 250.

According to embodiments of the invention, data integration module 320 may perform integration of various data, information or parameters. Such integration may comprise collecting relevant information or parameters from one or more input objects and prepare input data for processing by subsequent stages comprising processing module 250. For example, various parameters or information such as account number, customer name and/or other demographic information, date and time information, sum of the transaction and the like may be integrated into predefined formats and/or fields such that subsequent stages and/or modules may readily use integrated information in an efficient manner. According to embodiments of the invention, the definition and functionalities of module 320 may vary according to various parameters, for example, according to input data types and/or structures.

According to embodiments of the invention, analysis and enrichment module 330 may analyze input data, identify missing and/or required information and enrich, supplement, incorporate, combine or otherwise associate input data with additional information in order to prepare it for further processing. Possibly after identifying missing data, information and/or parameters module 330 may further collect, retrieve, extract or otherwise obtain such missing information. For example, module 330 may obtain information from various sources, possibly external to processing module 250. According to embodiments of the invention, sources such as Customer Relationship Management (CRM), Enterprise Resource Planning (ERP) systems or any other applicable information repository or system may be accessed by module 330 in order to obtain required information. For example, information such as employee identification of a person associated with a transaction or the employing organization of such customer may be obtained from a work force management system. Another function may be obtaining a price of an item specified in a purchase transaction where the item purchased is specified but the price is not. In such case the price may be obtained from an electronic catalog or other system or facility.

According to embodiments of the invention, module 250 may determine if a subset of rules selected from a plurality of rules apply to, or match, a transaction. For example, a plurality of rules may be applied to a transaction and a subset of such plurality may yield or produce a match, where a match as referred to herein may include for example an event where a predicate in a rule is true with regards to the transaction.

According to embodiments of the invention, rule execution module 340 may process input information such as digital transactions according to predefined rules and/or policies. According to embodiments of the invention, module 340 may obtain rules and/or policies from one of rules repositories 260, 261 and/or 262 described herein and may further apply or otherwise use these rules to process input data. According to embodiments of the invention rules may be associated with decisions and/or actions. According to embodiments of the invention, if applying or comparing a rule to an information object produces a match, for example conditions defined in the rule are met then the associated actions or decisions may be selected. A number of rules may be applied to a given data or information object such as a transaction record. Accordingly, a number of matches may be observed and accordingly, number of actions and/or decisions may be selected.

According to embodiments of the invention, one or more actions or decisions selected as described herein may be actually performed or otherwise acted according to. According to embodiments of the invention, rule conflict resolution may be executed by module 340. A subset of one or more actions and/or decisions may be selected for execution from a number of actions and/or decisions produced by matching rules. A number or set of matching rules may produce a respective set of contradicting, conflicting, incompatible, mutually exclusive or inconsistent set of actions and/or decisions. A conflict resolution process, possibly performed by module 340, may resolve such inconsistencies or conflicts and may produce, for example by omitting and/or altering some of the selected actions and/or decisions, a coherent, consistent set of actions and/or decisions for execution or further actions.

According to embodiments of the invention, decision and action execution module 350 may be provided with a set of actions to be executed or decisions that require further processing or actions. According to embodiments of the invention, module 350 may perform any required tasks necessary to complete the execution of actions and/or decisions produced by module 340. For example, module 350 may communicate alerts or warnings to one or more management module 210 or provide other information, parameters or indications to these or other systems or store log information in storage 230. Other possible actions may be a blocking of a transaction or manipulating a transaction. For example, if a rule dictates that a transaction is to be blocked then the transaction may be logged by module 350 and may further be dropped (e.g., the transaction is not forwarded to its destination). Alternatively, if a transaction is validated and/or approved it may be forwarded to its destination. According to embodiments of the invention, module 350 may instruct, command or otherwise cause any module, possibly external to processing module 250 to act. For example, module 350 may instruct the forwarding of the transaction to its destination, a logging of information, statistics or parameters, or any other functions required to complete actions produced by module 340 or required in order to comply with decisions produced by module 340.

According to embodiments of the invention, output module 360 may be similar in construction, design, implementation and other applicable aspects to input interface 310. According to embodiments of the invention, output module 360 may share some infrastructure with input interface 310, for example, a network interface card may be used for both input and output of data and accordingly may be shared by input interface 310 and output interface 360. According to embodiments of the invention, output module may assume any task related to outputting digital information from processing module 250. Such information may be for example commands or instructions to other modules in or outside fraud detection system 140 or it may be various indications provided to various modules in or outside fraud detection system 140. It will be noted that according to embodiments of the invention processing module 250 may comprise more, fewer or other modules than those described herein. It will also be recognized that modules shown and described herein are exemplary modules that may, according to some embodiments of the invention be merged, replaced or altered such that functionalities described herein are differently distributed and/or performed.

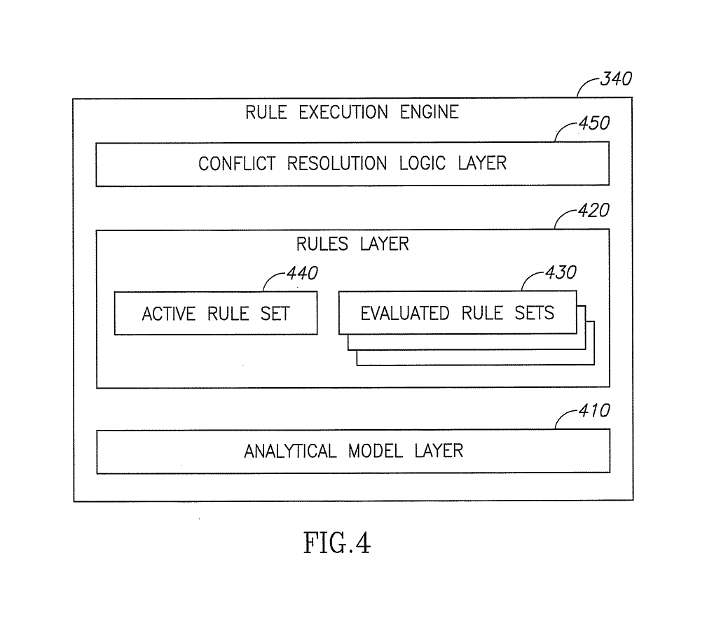

Reference is now made to FIG. 4 that shows a logical block diagram of a rule execution and conflict resolution engine according to embodiments of the invention. According to embodiments of the invention, rule execution module 340 may comprise an analytical model module or layer 410, a rules module or layer 420 comprising an active rule set 440 and an evaluated rule sets module 430, and a conflict resolution logic layer or module 450. It will be noted that an active rule set may also be referred to as a champion rule set while the evaluated rule sets may also be referred to as a challenger rule set or sets. The terms within the pairs active and champion, and challenger and evaluated, may be used interchangeably.

According to embodiments of the invention, analytical model layer or module 410 may comprise rules and/or statistical or other functions and the ability to apply these rules and functions to input information, data, e.g., transaction records. Analytical models, rules and functions may be defined by users that may be business oriented personnel, technical people, and/or specifically skilled personnel, e.g. people skilled in areas such as mathematics, statistics and the like. Analytical models, as defined according to the present invention, may be user-defined rules that require a high level of complex analytics capabilities in order to be executed. For example, a set of rules that define a way to detect fraud in a financial transaction system, based on parameters such as client profiles, transaction volume, currency type etc.

According to embodiments of the invention, input to module 340 may be provided to analytical model layer or module 410. According to embodiments of the invention, layer or module 410 may analyze large volumes of data. Such data may be transaction records or any other applicable data or information structures. Such data may originate from various and/or multiple sources. For example, data may come from an organization's internal sources or data repositories, e.g., an Enterprise Resource Planning (ERP) system or a Customer Relationship Management (CRM) system and/or any other applicable information repository. Alternatively, input data may be obtained from external sources, e.g., an organization's suppliers, customers or clients, for example, money transactions made by a bank's clients. According to embodiments of the invention, data provided to layer or module 410 as input to module 340 may be provided in off-line mode. For example, historical data may be retrieved from a data repository such as a data warehouse or other sources described herein, and provided as input to module 340. Alternatively, data may be provided to module 340 in real-time. For example, electronic transactions such as money transfers, purchase orders, or other electronic transactions may be routed via, or forwarded to module 340 as part of the business flow. Module 340 may be capable of monitoring, authorizing, blocking, prohibiting, filtering, manipulating, altering or otherwise affecting, transaction in progress.

According to embodiments of the invention, some of the above functions, e.g., filtering may be performed by layer or module 410. According to embodiments of the invention, layer or module 410 may perform pre-processing of input information such as transaction records and provide higher layer or modules, e.g., rules layer or module 420 with various information and parameters or otherwise prepare data for processing by higher layer or modules. Layer or module 410 may employ recognition logic and/or any applicable analytical or other methods or means to match or otherwise identify predefined events, conditions, parameters, paradigms, sequences, values, structures, thresholds, patterns, strings, segments or any other applicable information in provided input data. Layer or module 410 may further extract various parameters, segments, fields or information from input data or records and provide higher layer or modules with such extracted information. Such extraction may be according to user-defined business events or other criteria. For example, parameters such as customer name, country of origin, sum of transaction, source account number, and destination account number may be extracted by layer or module 410 from a transaction record and provided to higher layer or modules, e.g., rules layer or module 420.

According to embodiments of the invention, identifying relevant information as described herein may be performed by layer or module 410 according to analytical rules, such rules may reflect or be associated with predefined business flows, conditions, constraints or other business, organizational or other aspects, and other rules. According to embodiments of the invention, a rule may define a predicate that may be true or false when related to a digital object such as a digital transaction. An example of such a rule may be “the sum of withdrawals over the past week is less than 5 standard deviations of the weekly withdrawals during the past year” According to embodiments of the invention, layer or module 410 may select data or information such as transaction records to be processed by higher layer or modules and may filter out, or otherwise prevent further processing of other records or information. Such filtering may be performed according to rules such as described herein. For example, a logical filter may detect transactions associated with amounts larger than for example $1000. Such filter may only allow transaction associated with amounts larger than $1000 to be processed by higher layer or modules of module 340. Other exemplary criteria that may be handled by such logical filters may be customer's age, transaction's date and the like.

It will be recognized that according to embodiments of the invention, analytical model layer or module 410 may be, may comprise, may implement or may execute parts of any analytic, statistical or other systems, platforms or frameworks such as analytic CRM, analytic work or business flow systems, analytic rule based systems, statistical analysis systems, predictive methods, deterministic pattern identification systems and/or analytic or other data mining tools as known in the art.

According to embodiments of the invention, rules layer or module 420 may comprise and execute a plurality of user defined, or other rules. Such rules may be defined by users using various, possibly external to module 340, graphical tools, e.g., graphical user interface (GUI) tools. According to embodiments of the invention, active rule set 440 may comprise rules applied to information and/or data such as transaction records provided by analytic layer or module 410. According to embodiments of the invention, such information, data and/or transaction records may be live traffic, e.g., ongoing transactions. Application of rules and/or manipulation of rules or rule sets may be performed in real-time, e.g., a rule set may be removed or modified, or an evaluation rule set may be made active without stopping the traffic or flow of input data to module 340. In some embodiments of the invention, only parts, segments or selected fields of an input record as provided to layer or module 410 may be provided to layer or module 420. For example, various segments or fields in a transaction record may be filtered out by module 410 and only the remaining sections or selected sections may be provided to module 420.

According to embodiments of the invention, rules in sets 440 and 430 may be configured to find, identify, spot, recognize, distinguish, detect and/or discover events, conditions, parameters, paradigms, sequences, values, structures, thresholds, patterns, strings and/or segments in input data such as a transaction record. According to embodiments of the invention, active rule set 440 may be associated with decisions, actions or functions. According to embodiments of the invention, rules may associate or condition an action or decision with a detection of preconfigured condition, parameter, paradigm, sequence, value, structure, threshold, pattern, string, segment. According to embodiments of the invention, a rule may, upon detecting preconfigured events, conditions, parameters, paradigms, sequences, values, structures, thresholds, patterns, strings or segments in a transaction record cause an action or decision to be taken.

For example, a rule may state the following: “if the source of the transaction is Nigeria and the age of the customer associated with the transaction is less than 21 then block the transaction”. As demonstrated by the exemplary rule above, rules may be applied to information or context information provided by underlying analytic layer or module 410 that may have extracted such context information from an input data structure such as a transaction record. According to embodiments of the invention, decisions, actions or functions associated with rules may be related to any applicable aspect or dimension of the processed information and/or context of relevant business. For example, decisions and/or actions may be to block a transaction, report a transaction to a supervisor or other personnel or entity, or file a suspicious activity report (SAR), log the transaction, authenticate the transaction, issue an alert or any applicable decision or action. According to embodiments of the invention, a decision or action associated with a rule may activate or be otherwise associated with modules, systems or any other entity possibly external to module 340. For example, an action may cause a system such as an electronic mailing or paging system to act, e.g., to send electronic mail or page a supervisor or an action may cause recording system to commence a recording of a session associated with a specific transaction, possibly by providing such recording system with sufficient information required to identify the session.

According to embodiments of the invention, some of the rules in active rule set 440 may be applied to provided data or records. Applying the rules from active rule set 440 may be done serially, one rule at a time and one rule after the other or it may be done in parallel, e.g., some or all of the rules may be applied or executed substantially simultaneously or concurrently. Since according to embodiments of the invention, rules execution or application conflicts may be resolved at a stage subsequent to rules execution or application, the order of rules execution may be chosen or configured according to various considerations, e.g., implementation considerations, computing resources utilization, execution priorities and the like.

According to embodiments of the invention, a rule may define and/or comprise a predicate that may be true or false with regard to a digital or information object. For example, a digital object may be a money or financial transaction. According to embodiments of the invention, a rule may produce or yield a match, or simply match, if when applied or compared to an information object, the predicate in the rule is true with regards to the digital transaction. According to embodiments of the invention, if a rule matches then the action associated with the rule may be selected as a candidate for execution. However, if a number of rules, e.g., all rules in active rule set 440, are applied to a single transaction then a number of actions may be selected as a result of a number of rules producing a match. Such number or plurality of actions may be conflicting actions, e.g., a first action may be to block the transaction while a second action may be to allow or pass the transaction. Embodiments of the invention may resolve such conflicts as discussed herein, or provide other or different benefits.

According to embodiments of the invention, at least some of the rules in a rule set such as active rule set 440 or evaluated rule sets 430 may be associated with a priority level and may accordingly be referred to herein as “priority rules”. The term “priority” used herein with reference to a rule or action may refer to a “priority level”. According to embodiments of the invention, priorities assigned to rules within a given set may be unique, namely, no two rules in a given set are assigned the same priority level. According to embodiments of the invention, in addition to assigning priorities to rules, unique priorities may also be assigned to actions, decisions or functions described herein. According to embodiments of the invention, priorities assigned to rules and actions may be defined and assigned by a user, for example as part of defining a rule, associating a rule with an action and/or inserting a rule into a rule set.

According to embodiments of the invention, as a result of executing a plurality or set of rules in relation with a transaction, a subset of rules from the set may match or apply. For example, a predicate defined in or by a subset of rules from the set may be true with regard to the transaction. Each of such matching rules may correspond to an action as described herein, and may also correspond to a priority level. Actions with which rules correspond may correspond to a priority level, also referred to herein as action priority or action priority level. When used herein set and subset may include a variable number of objects, including one object.

For example, a rule set, e.g., active rule set 440 or one of evaluated rule sets 430, may include for example four rules each associated with an action. The first rule may be assigned priority level 10, the second rule may be assigned priority level 6 and the third and fourth rules may be assigned no priorities. The actions associated with the first, second, third and fourth rules may be assigned respective priorities 1, 2, 3 and 4. Other numbers of rules may associated with rule sets.

According to embodiments of the invention, the four rules in the exemplary set may be applied to a transaction. According to embodiments of the invention, if one or more matching rules are priority rules (rules assigned a priority level) then the action to be performed may be the action associated with the priority rule assigned the highest priority level. For example, if the first, second and third rules match, then only priority rules (first and second) may be considered. Since the first rule is assigned a higher priority (e.g., priority level 10) than the second rule (e.g., priority level 6), the action to be executed may be the one associated with the first rule. According to embodiments of the invention, if none of the matching rules are priority rules then the action to be performed may be selected according to priorities assigned to actions. For example, if the third and fourth rules in the above exemplary rule set match then the action associated with the fourth rule may be selected for execution since it is assigned a priority level 4, higher than the priority level of the third rule (3). According to embodiments of the invention, a higher priority level number may indicate higher priority level, e.g., 5 is a higher priority level than 4, or lower priority level, e.g., 17 is a lower priority than 9. While when used herein “higher” priority is indicated by a larger number, in other embodiments higher priority may be indicated by a lower number, and priorities may be indicated by other symbols, e.g. letters.

According to embodiments of the invention, rules may be added or removed to/from active rule set 440 in real-time, e.g., without stopping or otherwise disrupting input flow to module 250. According to embodiments of the invention, rules may be temporarily removed from active rule set 440 to see the resulting effect. The rules may further be modified and the modified version may be added back to active rule set 440. According to embodiments of the invention, active rule set 440 may comprise any number of rules. Such rules may co-exist and may be executed concurrently, in real-time.

According to embodiments of the invention, choosing an action to be performed may be performed by conflict resolution logic layer or module 450. Layer or module 450 may observe rules priorities and decisions priorities of the resulting set of actions, where a “resulting set of actions” or “resulting action set” may be the set of actions produced by executing or applying the set of rules in a rule set, e.g. active rule set 440, on input data or record. It should be understood that a resulting action set may not necessarily be executed, a resulting set of actions as referred to hereinafter may denote the set of actions produced by executing a set of rules. According to embodiments of the invention, only a subset of a resulting set of actions may be actually performed.

According to embodiments of the invention, a rule may be associated with a plurality of actions. Typically, actions associated with a rule fall into one or more categories or planes. Exemplary categories or planes may be a reporting category, a stall or delay category or plane and a block/allow or pass plane. Other categories or planes may be used. For example, a reporting plane may include actions such as “report SAR”, “report OFAC” and “report to supervisor”. A delay plane may include actions such as “stall short” that may cause a short delay to be applied and “stall long” that may cause a long delay to be applied to a transaction in process. Accordingly, a block/allow plane may include a “block” action that may block a transaction and an “allow” or “pass” action that may cause the transaction to proceed. According to some embodiments of the invention, categories or planes may be defined such that actions from one category do not conflict with actions from a second category or plane. For example, a transaction that was blocked or allowed (actions included in a first plane) may be reported or may not be reported (actions included in a second plane).

Accordingly, according to embodiments of the invention, conflict resolution may be performed with respect to a given action plane or category. For example, conflict resolution of a set of actions produced by applying a set of rules to a transaction may comprise iterating over all action planes or categories, observing all actions produced in a given plane and selecting action within a plane, for example, selecting the action associated with the highest priority level.

According to embodiments of the invention, actions may be associated with priorities. Actions within an action plane or category may be assigned unique priorities. According to some embodiments of the invention, no two actions within an action plane are assigned the same priority or priority level. For example, a “block” action may be assigned a higher priority than an “allow” or “pass” action. Accordingly, if three rules in an applied rule set yield a “pass” action and a fourth rule yields a “bock” action than the action selected may be the “block” action as, within the relevant plane, this would be the action associated with the highest priority level.

According to embodiments of the invention, a rule may produce one or more actions. According to some embodiments of the invention, a rule may produce one action per action plane or category. Accordingly, a conflict resolution algorithm, method, paradigm and/or process may observe all actions produced by a number of rules and associated with the same plane or category and select the action with the highest priority level. For example, such conflict resolution may be performed by CPU 273 by executing code comprised in module 250 as described with reference to FIG. 2B.

According to embodiments of the invention, a conflict resolution process's output may be a non-conflicting set of actions per rule set. For example, when mutual exclusive actions, e.g., “allow” and “block” are detected then the mutual exclusiveness may be resolved by the fact that such actions are associated with the same plane and further by the fact that actions within a plane or category are assigned unique priorities.

According to some embodiments of the invention, layer or module 450 may resolve conflicts within each rule set. For example and as shown, evaluated rule sets 430 may comprise a number of rule sets, each of which comprising one or more rules. Each set of rules may yield or produce a number of actions or decisions as a result of being applied to an input transaction. According to some embodiments of the invention, an action vector, typically comprising one or less action per action plane may be produced for each relevant rule set. Such an action vector may include, per plane, the action with the highest priority level as selected from all actions produced by applying or executing some or all rules in the rule set.

It will be noted that more than one action per action plane may be selected according to some embodiments of the invention. For example, non-conflicting actions within an action plane or category may be assigned the same priority level. Accordingly, if a first rule applied produces a first such action and a second rule executed produces a second such non-conflicting action associated with the same plane then both actions may be selected.

According to embodiments of the invention, conflict resolution layer or module 450 may utilize various algorithms, heuristics, logic or any applicable methods in order to select one or more actions from a resulting action set. For example, choosing an action to perform with relation to a processed record may be done according to the following scheme: if one of the rules executed is assigned a priority level, namely, it is a “priority rule” then the action associated with the “priority rule” associated with the highest priority level is selected, if none of the resulting actions is associated with a priority rule then the action associated with the highest priority level is selected. According to embodiments of the invention, the action selection method or algorithm described herein may enable embodiments of the invention to concurrently, simultaneously and/or independently execute or apply any number of rules to a given, single data object such as a transaction record or other applicable input information. According to embodiments of the invention, any number of rules may be concurrently, independently and/or simultaneously applied to, or executed on a single transaction record and such concurrent, independent and/or simultaneous execution may yield a consistent, non-contradicting, coherent set of actions to be performed as a result.

According to embodiments of the invention, possibly in addition to assigning priorities to actions, decisions or functions as described herein, actions decisions or functions associated with rules may further be grouped or categorized according to dimensions or defined categories that may be defined by a user or administrator of a system comprising module 340. For example, operations, functions or actions such as reporting, alerting or modifying, logging or blocking may be categorized according to various criteria or business dimensions. According to embodiments of the invention, actions or decisions priorities within a category may be unique, namely, no two actions within a given category are assigned the same priority level.

According to embodiments of the invention, selecting actions or decisions as described herein may be further performed within categories or layers e.g., only one action from set of actions produced by executing or applying a set of rules and/or from a given category or defined group may be actually selected and performed. Such layered configuration or architecture may allow embodiments of the invention to select more than one action or decision from a resulting action set to be performed while preventing contradicting actions to be preformed on a given data or transaction record.

For example, actions that modify a transaction record may be associated with the same category. If two or more resulting actions comprise modifying a transaction record, then only one such action may be performed, thus consistency and coherency of processed information may be preserved. Another example of contradicting actions may be modifying a transaction and recording it. If a transaction is to be recorded for some reasons, then it is probably desired to record the transaction without, or at least before it is being modified, accordingly, by categorizing actions, such contradicting, or conceptually mutually exclusive or conflicting actions may be avoided while still enabling multiple actions to be selected and performed on, or in association with, a given transaction or input information object or data. Any applicable additional logic, algorithms or schemes such as described herein may be performed by conflict resolution logic layer or module 450.

Embodiments of the invention may enable concurrent, simultaneous or serial execution of any number of rules while ensuring consistency and coherency of results of such execution, e.g., of actions selected for execution. According to embodiments of the invention, a rule set such as active rule set 440 may be dynamically modified. According to embodiments of the invention, input of data to rules layer or active rule set 440 or module 340 need not be stopped or otherwise manipulated in order to modify active rule set 440. According to embodiments of the invention and possibly due, at least in part, to concurrent and independent rule execution as described herein, rules may be dynamically, ad-hoc or on-the-fly added to, or removed from, active rule set 440. According to embodiments of the invention, such modification may be applied to active rule set 440 without stopping, disrupting or otherwise affecting a flow of input data to module 340. Such dynamic modification may enable users of a system comprising module 340 to dynamically and quickly react to changing conditions such as new threats, e.g., information indicating possible fraudulent activities. Independent rule execution as described herein may allow users to focus on the rule they are working on without the burden of having to monitor, correct or be otherwise concerned with other rules. This may be extremely valuable when considering that in some embodiments a system may comprise hundreds of user defined rules making the correlation of rules, namely ascertaining coherency and consistency of rules execution a considerable task.

According to embodiments of the invention, rules in active rule set 440 and rules in evaluated rule sets 430 may be user defined, or other types of rules. According to embodiments of the invention and as shown by evaluated rule sets 430, one or more rule sets may be evaluated by a user. Evaluation of rule sets may be performed during or while an active rule set is being executed as described herein. Evaluation of rules may be performed by applying evaluated rules to input data in a similar manner described herein with regard to active rule set 440. A main operational difference between an evaluated rule set such as one of the sets indicated by 430 and an active rule set such as active rule set 440 is that no action is actually performed as a result of executing or applying rules associated with or belonging to an evaluated rule set. An outcome of executing evaluated rule sets may be for example a presentation of information to a user.

According to embodiments of the invention, evaluated rule sets 430 may be used n order to evaluate the effectiveness of new rules or new combinations of rules. According to embodiments of the invention, actions selected as a result of executing rules in evaluated rule sets 430 may not be executed, but may be presented to a user. Such presentation may enable a user to, for example, evaluate rules in evaluated rule sets 430. For example, as conditions, circumstances or environments change, new rules, combinations or rule sets may be evaluated and eventually made active. For example, a new threat such as employees' fraudulent activities may be detected (e.g., bank employees appearing to be involved in fraudulent activities is suspected), or a new or new type of remote fraud scheme or paradigm is suspected or discovered. Such new threats and/or information may cause a user of embodiments of the invention to author new rules and/or combine new and/or existing rules into new rule sets and further test or evaluate such new rules and/or rule sets by adding them to evaluated rule sets 430 and observe the output of such new additions. For example, using one of authoring tools comprised in rules authoring module 220 a user may load a rule from rule repository 278, edit the rule, change definitions of the rule, e.g., assign or change a priority level. According to embodiments of the invention, management module 210 may enable a user to manipulate a rule set, for example, add a rule to a rule set or remove a rule from a rule set. According to embodiments of the invention, management module 210 may enable a user to designate a rule set as the active rule set.

According to embodiments of the invention, as a result of executing evaluated rule sets 430 a user may be provided with information such as any relevant information pertaining to data processed, e.g., various details pertaining to transactions, such as, sums involved, source and destination details such as source and destination bank accounts, date and time information and/or any other applicable or relevant information. In addition, a user may be provided with information regarding selected actions, decisions or functions that resulted from an execution of an evaluated rule or rule set. Such presentation may enable a user to evaluate a rule set and view, in real-time the effect of changes, modifications or alterations made to such set. For example, rules may be added or removed from an evaluated set, rules may be temporarily removed from a set to see the resulting effect, rules may further be modified and the modified version may be added back to the evaluated set. According to embodiments of the invention, any number of evaluated rule sets may co-exist and may be executed concurrently, in real-time.

According to embodiments of the invention, any one set from evaluated rule sets 430 may be selected to be an active set. For example, at any point in time, a user may select or designate a set from evaluated rule sets 430 to be the active rule set, e.g., by replacing active rule set 430. According to embodiments of the invention, the user may be enabled to elect whether the former active set will be added to the evaluated group or be simply removed from the system. A swap operation may be performed where by a selected set from the evaluated sets is to become an active set and an active set is to be evaluated, namely, added to the group of evaluated rule sets. Operations described herein, e.g., a swap operation as described, a designation of an evaluated rule set as an active set, removing a rule set and/or adding a rule set may be performed in real-time or on-the-fly, e.g., without stopping, disrupting or otherwise affecting the processing of input data. According to embodiments of the invention, a flow of input data objects, information, transactions or transaction records may be continued while such operations or manipulation of rule sets are performed. Such flexibility and dynamicity of rules selections may give users unprecedented capabilities of configuration and tuning and may enable users to get clear view of the way their rules affect the overall performance and accuracy of module 340. Effectiveness, accuracy and/or any other aspects of new or existing fraud identification methods may be evaluated, in real-time and may further be tuned, in the field, with live traffic in ways impossible before.

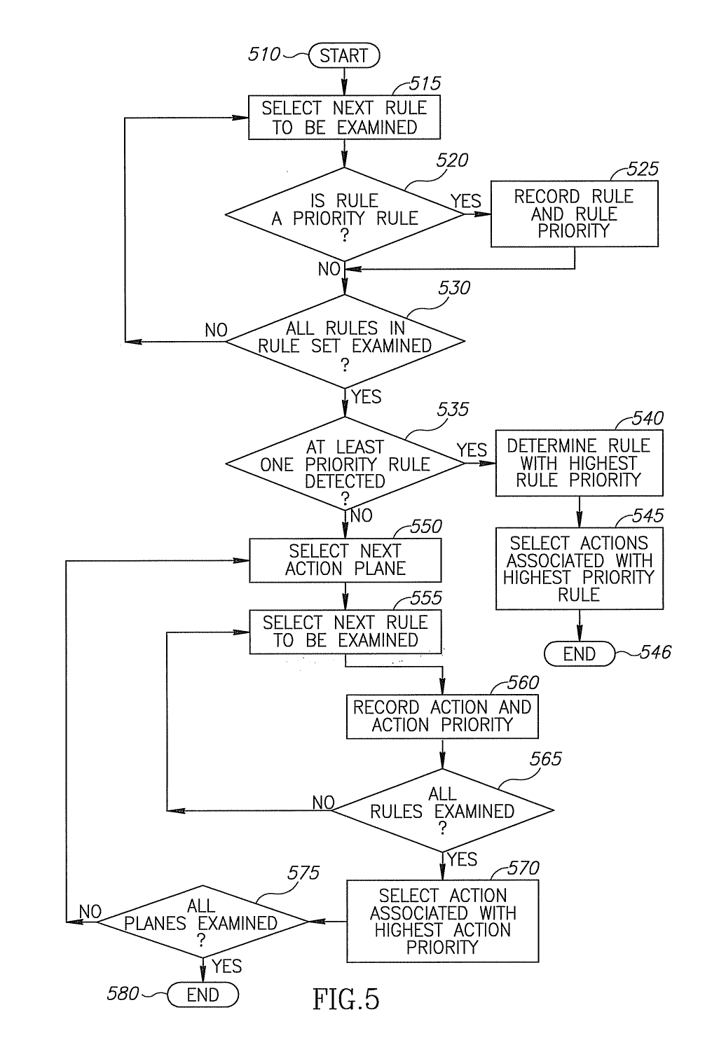

Reference is now made to FIG. 5 depicting an exemplary flow for conflict resolution according to embodiments of the invention. Such flow and logic may be implemented by for example CPU 273 by executing code in data and rule processing module 250 described herein, but other entities may perform such functions. According to embodiments of the invention and as shown by block 510, the flow may include a start point. According to embodiments of the invention and as described herein, conflict resolution may be performed per rule set. In some embodiments of the invention, conflicts are only resolved between actions associated with a specific rule set. Accordingly, a rule set for which conflicts are to be resolved may be selected at start point 510.

According to embodiments of the invention and as shown by blocks 510 and 530, the flow may iterate over all rules in a rule set. Accordingly, as shown by block 515, rules may be selected for examination by any order. Typically, rules may be selected sequentially from the first rule in the set to the last one. According to embodiments of the invention and as shown by block 520, a selected rule may be examined to determine if it is a priority rule. In block 525, if the selected rule is a priority rule then the rule and its associated priority level may be recorded. According to other embodiments of the invention, rather than recording the rule and associated priority, only the priority rule associated with the highest priority thus far detected is recorded. Such implementation may improve performance by saving memory for recording all detected priority rules and by bypassing the need to search for, or determine, the highest priority rule in a list at a subsequent stage.

As shown by block 530, the flow may include checking if all rules in the set have been examined. If so, the flow may proceed, if not, the next rule may be selected as shown by the arrow connecting blocks 530 and 515. According to embodiments of the invention and as shown by blocks 535, possibly subsequent to iterating over all rules in the set, the flow may include if at least one priority rule has been detected. If so, as shown by block 540, the flow may include determining the priority rule associated with the highest priority and, as shown by block 545, selecting the actions associated with that rule. In block 546, possibly subsequent to detecting a priority rule and selecting actions associated with it, the flow may terminate. According to embodiments of the invention, following such termination, selected actions may be provided to external systems as described herein, to a management system such as a case management tool or to any other applicable system, module or application.

According to embodiments of the invention, if the priority rule selected as described herein is only associated with actions from some of the defined action planes or categories then the flow may proceed as shown by block 550. According to embodiments of the invention, actions associated with action planes or categories for which the priority rule has no actions defined may be selected.

In block 550, if no priority rules have been detected in the relevant rule set, the flow may include iterating over some or all defined action planes or categories. Accordingly, action planes may be selected one after the other as shown by block 550. For each selected action plane, some or all rules associated with the relevant rule set may be examined to determine if an action associated with the selected action plane is defined for, or associated with, the examined rule. Accordingly, as shown by blocks 555 and 565, the flow may iterate over some or all rules in the rule set selected as described with reference to block 510.

In block 560, the flow may include recording, for example in a list that may be sorted at a later stage, the action and the action priority of the action associated with the selected action plane and the selected rule. According to embodiments of the invention and as shown by block 565, recording actions associated with a specific action plane may be done for some or all rules in the selected rule set and may, accordingly terminate when all rules in the rule set have been examined.

According to embodiments of the invention and as shown by block 570, possibly subsequent to recording all actions associated with a specific action plane, the action associated with the highest priority within an action plane may be selected. Such action may be, at this or later stage, provided to external systems 290, for example by being incorporated into an action stream as described herein. Exemplary actions may be for example recording of a transaction, logging a transaction, blocking a transaction, altering a transaction etc. Such actions may be performed by systems external to fraud detection system 140, e.g., external systems 290. According to embodiments of the invention, an action sent to an external system may command or cause an external system to perform the action. Any applicable protocol, e.g., HTTP, SOAP, remote procedure call (RPC) etc. may be used by system 140 to communicate commands and/or actions to be performed to external systems 290. According to embodiments of the invention, upon receiving an action from system 140, an external system may perform the action and may further report execution results to system 140.

Alternatively or additionally, the selected action may be provided to a management tool. For example, if the relevant rule set is an evaluated rule set then the action may not be provided to any execution system or module but rather to a case management or other tool whereby a user may be provided with information enabling him or her to evaluate the rule set.

In block 575, the flow may include determining that all action planes have been examined as described herein, if so, as shown by block 580, the flow may terminate. According to embodiments of the invention, termination of the flow may include providing any collected or otherwise obtained information to relevant systems or modules as described. For example, rather than providing the selected action as described herein with reference to block 570, actions may be recorded or otherwise stored, for example, in memory 275 or storage device 280 and collectively provided upon termination of the flow. According to embodiments of the invention and as shown by the arrow connecting blocks 575 and 550, if not all action planes have been examined then the flow may proceed to selecting the next action plane.

According to embodiments of the invention, methods, procedures, functions and/or operations described herein may be performed by an apparatus, device, machine or any other suitable equipment, e.g., computing device 289. For example, a computing device equipped and/or outfitted with suitable hardware and/or firmware components and further executing one or more programs, applications, scripts and/or any suitable software code and digital information may perform methods, procedures, functions and/or operations described herein. Such software may further be divided to modules. For example, a first module may handle input output and network connectivity, a second module may handle data integration and/or analysis, a third module may perform rules execution and conflict resolution etc.

Some embodiments of the present invention may be implemented in software for execution by a processor-based system. For example, embodiments may be implemented in code and may be stored on a storage medium having stored thereon instructions which can be used to program a system to perform the instructions or which, when executed by a processor or controller, cause the processor or controller to carry out a method according to an embodiment of the present invention. The storage medium may include, but is not limited to, any type of disk including floppy disks, optical disks, compact disk read-only memories (CD-ROMs), rewritable compact disk (CD-RW), and magneto-optical disks, semiconductor devices such as read-only memories (ROMs), random access memories (RAMs), such as a dynamic RAM (DRAM), erasable programmable read-only memories (EPROMs), flash memories, electrically erasable programmable read-only memories (EEPROMs), magnetic or optical cards, or any type of media suitable for storing electronic instructions, including programmable storage devices.

Such a system may include components such as, but not limited to, a plurality of central processing units or any other suitable multi-purpose or specific processors or controllers, a plurality of input units, a plurality of output units, a plurality of memory units, and a plurality of storage units. Such system may additionally include other suitable hardware components and/or software components.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claimed is:

1. A method comprising:
determining from a plurality of rules which rules in a subset of the plurality of rules apply to a transaction, each rule corresponding to an action, some of the rules corresponding to a priority level, each action corresponding to a priority level;
if one or more rules from the subset of rules has a priority level, selecting the action associated with the rule having the highest priority level; and
if none of the rules from the subset of rules has a priority level, selecting the action having the highest priority level.

2. The method of claim 1, comprising executing the selected action.

3. The method of claim 2, wherein performing the selected action comprises sending a message to an entity which, in response, performs the selected action.

4. The method of claim 1, comprising displaying to a user the selected action.

5. The method of claim 1, comprising logging the selected action.

6. The method of claim 1, wherein the plurality of rules are selected from at least an active rule set and from an evaluated rule set and:
for each selected action associated with the active rule set, executing the selected action; and
for each selected action associated with the evaluated rule set, presenting to a user information pertaining to said selected action.

7. The method of claim 1, comprising, before determining from a plurality of rules which subset of the plurality of rules applies to a transaction, applying at least one analytical rule to the transaction, and wherein said determining is based on a result of said applying at least one analytical rule.

8. The method in claim 1, comprising selecting a plurality of actions from a respective plurality of action planes.

9. A system for processing a digital transaction record, the system comprising:
a memory to store at least one set of rules wherein each rule corresponds to an action, some of the rules corresponding to a priority level and each action corresponds to a priority level; and
a processor to:
determine for each of said at least one set of rules which rules in a subset of rules apply to said digital transaction record,
if one or more rules from the subset of rules has a priority level, select the action associated with the rule having the highest priority level,
if none of the rules from the subset of rules have a priority level, then select the action having the highest priority level.

10. The system of claim 9, wherein said processor is to execute said selected action.

11. The system of claim 10, wherein executing the selected action comprises sending a message to an entity which, in response, performs the selected action.

12. The system of claim 10, wherein said processor is to display to a user said selected action.

13. The system of claim 10, wherein said processor is to log said selected action.

14. The system of claim 10, wherein said memory is to store at least an active rule set and an evaluated rule set and wherein for each of the active and evaluated rule sets said processor is to:
determine which subset of rules apply to a transaction, and
if one or more rules from the subset of rules has a priority, select the action associated with the rule having the highest priority,
if none of the rules from the subset of rules have a priority level, then select the action having the highest priority level,
execute the selected action associated with the active rule set and present to a user the selected action associated with the evaluated rule set.

15. The system of claim 10, wherein said memory is to store at least one analytical rule and wherein said processor is to determine from a plurality of rules which subset of the plurality of rules applies to a transaction subsequent to applying said at least one analytical rule to said transaction, and wherein said determining is based on a result of said applying at least one analytical rule.

16. The system of claim 10, wherein said processor is to simultaneously apply said plurality of rules to said transaction.

17. The system of claim 10, wherein said processor is to enable a user to designate, in real-time, an evaluated rule set as an active rule set.

18. The system of claim 10, wherein said processor is to enable a user to add a rule to a rule set in real-time.

19. The system of claim 10, wherein said processor is to enable a user to remove a rule from a rule set in real-time.
